(19) United States
(12) Patent Application Publication
(10) Pub. No.: US 2008/0117850 A1
(43) Pub. Date: May 22, 2008

(54) Dual Mode Wireless Personal Area Network and Wireless Local Area Network Architecture

(76) Inventors: Dharma P. Agrawal, Cincinnati, OH (US); Carlos Cordeiro, Portland, OR (US)

Correspondence Address: DINSMORE & SHOHL, LLP, 1900 CHEMED CENTER, 255 EAST FIFTH STREET, CINCINNATI, OH, 45202, US

(21) Appl. No.: 11/929,172

(22) Filed: Oct. 30, 2007

Related U.S. Application Data
(60) Provisional application No. 60/855,288, filed on Oct. 30, 2006.

(51) Int. Cl. G08C 17/00; H04B 7/14

(52) U.S. Cl. 370/311; 370/315

(57) ABSTRACT

Dual mode wireless radio chip having integrated circuitry enabled to provide a wireless personal area network protocol layer; a wireless local area network protocol layer; and a radio access control protocol layer having a single antenna configured to receive and forward a plurality of transmission packets and to multiplex the wireless personal area network protocol layer and the wireless local area network protocol layer by placing the wireless personal protocol layer and the wireless local area network protocol layer in one or more plurality of operational modes.

### CROSS REFERENCE TO RELATED APPLICATION

This application claims priority from U.S. Provisional Patent Application Ser. No. 60/855,288 filed on Oct. 30, 2006. The entire disclosure of which is hereby incorporated by reference herein.

### BACKGROUND OF THE INVENTION

Wireless technology has become the heart of a networking infrastructure for localized data delivery. This revolution has been made possible by the introduction of new networking technologies and paradigms, such as wireless personal area networks (WPANs) and wireless local area networks (WLANs).

WPANs are short to very short-range (from a couple centimeters to a couple of meters) wireless networks that may be used to exchange information between devices within the reach of each person. WPANs can be used to replace cables between computers and their peripherals, to establish communities helping people do their everyday chores, thereby enhancing their productivity, or to establish location aware services. On the other hand, WLANs provide a larger transmission range. Although WLAN devices do carry the capability for ad hoc networking, the premier choice is to deploy for a cellular like infrastructure mode to interface wireless users with the Internet. One example of a WPAN is the industry standard Bluetooth, whereas for WLANs, the most well known representative is based on the standard IEEE 802.11 and all its variations. The wide applicability of IEEE 802.11 and Bluetooth are evident, and these two technologies are complementary to each other since the former is well suited for WLANs while the latter for WPANs. Moreover, it is foreseen that not only various devices such as pens, cameras, headsets, notebooks, etc., will be equipped with Bluetooth™ but they also will soon outnumber the computers on the Internet.

These technologies are complementary to each other and the present inventors have recognized an environment such that many Bluetooth devices can access information from the outside world, including the Internet, by using the existing widespread installed base of IEEE 802.11 WLANs. Therefore, it is desirable to provide Bluetooth devices with access to wide area networks such as the Internet by combining WLAN and WPAN in a signal chip that comprises a dual mode architecture.

### SUMMARY OF THE INVENTION

Embodiments of the present invention relate generally to a heterogeneous wireless network architecture, such that WPAN enabled devices can utilize WLAN protocols to access advanced services. Embodiments of the present invention merge the functionalities of a WLAN radio interface card (RIC), such as IEEE 802.11, with that of a WPAN RIC, such as Bluetooth, to form a single one-chip, dual mode, bandwidth efficient, cost-effective solution for the integration and cooperation of WLAN and WPAN technology. The present invention thereby enables Bluetooth devices to have access to potentially all applications available on the Internet, for example.

More specifically, embodiments of the present invention utilize various operational modes available in Bluetooth to schedule the alternation between WPAN and WLAN. The enabled devices may synchronize their schedules, enabling sharing of resources (e.g., Internet access) between Bluetooth and IEEE 802.11, employing pre-existing base of IEEE 802.11 networks without any extra cost, providing a one-chip solution, and improving wireless bandwidth efficiency.

According to one embodiment of the present invention, a dual mode wireless radio chip having integrated circuitry enabled to provide a wireless personal area network protocol layer, a wireless local area network protocol layer and a radio access control protocol layer is provided. The radio access control protocol layer comprises a single antenna configured to receive and forward a plurality of transmission packets and to multiplex the wireless personal area network protocol layer and the wireless local area network protocol layer by placing the wireless personal area network protocol layer and the wireless local area network protocol layer in one or more plurality of operational modes. The radio access control protocol layer is further configured to provide wireless local area network communication and wireless personal area network communication simultaneously to a plurality of wireless personal area network enabled devices is provided.

According to another embodiment of the present invention, a method of multiplexing a wireless local area network and wireless personal area network communication protocol is provided. The method comprises providing a dual mode wireless radio chip in a device, the chip comprising a wireless personal area network protocol layer and a wireless local area network protocol. Next, the method comprises receiving a packet transmission from a wireless local area network access point, determining whether a wireless local area network-only scenario, a wireless personal area network-only scenario, a cooperative data scenario or a cooperative voice scenario is present. The next step comprises placing the wireless personal area network protocol layer in a park mode if a wireless local area network-only scenario is present, placing the wireless network area network protocol layer in a power save mode if a wireless personal area network-only scenario is present, placing the wireless personal area network protocol layer in a sniff mode if a cooperative data scenario is present, and placing the wireless personal area network protocol layer in a hold mode if a cooperative voice scenario is present. Finally, the method comprises forwarding the packet transmission to an appropriate chip protocol layer.

According to yet another embodiment of the present invention, an integrated wireless personal area network and wireless local area network system is provided. The system comprises a wireless local area network access point and a wireless personal device network. The wireless personal device network further comprises a plurality of slave devices configured to have wireless personal area network access and at least one wireless gateway device. The at least one wireless gateway device comprises a dual mode wireless radio chip having integrated circuitry enabled to provide: a wireless personal area network protocol layer, a wireless local area network protocol layer and a radio access control protocol layer comprising a single antenna, wherein the radio access control protocol layer is configured to provide wireless local area network communication and wireless personal area network communication simultaneously to a plurality of wireless personal area network enabled devices, whereby the at least one wireless gateway device provides the wireless personal device network access to a wireless local area network.

### BRIEF DESCRIPTION OF THE DRAWINGS

The embodiments set forth in the drawings are illustrative and exemplary in nature and not intended to be limited of the inventions defined by the claims. Moreover, the individual features of the drawings will be more fully apparent and understood in view of the detailed description. The following detailed description of specific embodiments of the present invention can be best understood when read in conjunction with the following drawings, where like structure is indicated with like reference numerals and in which:

FIG. 1 is a schematic illustration of a time division multiplexing scheme of a wireless personal area network protocol in accordance to one embodiment of the present invention;

FIG. 2 is a schematic illustration of an integrated wireless personal area network and a wireless local area network system in accordance to one embodiment of the present invention;

FIG. 3 is a schematic illustration of a protocol stack of a dual mode wireless radio chip in accordance to one embodiment of the present invention.

### DETAILED DESCRIPTION

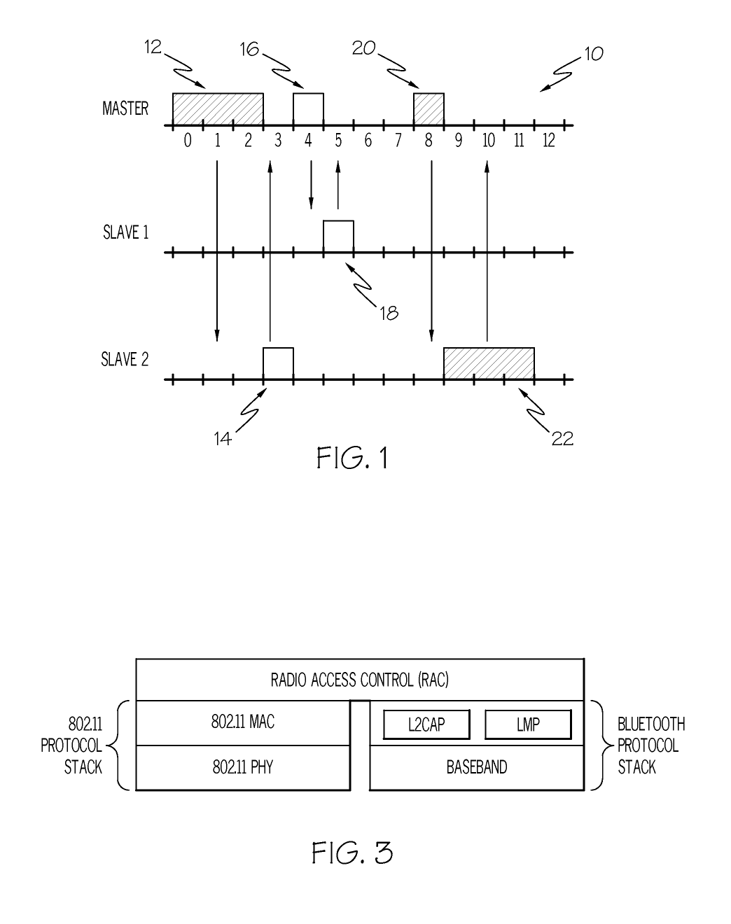

FIG. 1 illustrates a time division multiplexing scheme between a WPAN master device and two WPAN slave devices. Bluetooth™ is a short-range (up to 10 m) wireless link technology aimed at replacing cables that connect phones, laptops, PDAs, and other portable devices. Bluetooth radio transmission uses a slotted protocol with a FHSS (Frequency Hopping Spread Spectrum) technique operating in the ISM frequency band starting at 2.402 GHz and ending at 2.483 GHz in USA and most European countries. A total of 79 RF channels of 1 MHz width are defined, where the raw data rate is 1 Mbit/s. A Time Division Multiplexing (TDD) scheme divides the channel into 625 μs slots and, with a 1 Mbit/s symbol rate, a slot can carry up to 625 bits. Transmission occurs in packets that occupy 1, 3 and 5 slots. Each packet is transmitted on a different hop frequency with a maximum frequency hopping rate of 1600 hops/s.

Bluetooth operates on a master-slave concept wherein the master for a particular set of connections is defined as the device that initiated the connections. The master periodically polls the slave devices and only after receiving such a poll is a slave allowed to transmit. A master device can directly control up to seven active slave devices in what is defined as a piconet. Multiple piconets can be linked together through common Bluetooth devices to form a scatternet, which is a multi-hop Bluetooth network.

The Bluetooth specification defines two distinct types of links for the support of voice and data applications, namely, SCO (Synchronous connection-oriented) and ACL (Asynchronous connectionless). SCO supports point to point voice switched circuits while ACL supports symmetric as well as asymmetric data transmission.

In order to guarantee a minimal quality of service, Bluetooth allows each master/slave pair to agree on a maximum interval Tₚₒₗₗ, (measured in slots) between two consecutive polls by the master. An example of the TDD medium access control is depicted in FIG. 1. Here, the piconet master sends a 3-slot packet 12 to the second of its two slaves in the slots 0 to 2. In most cases, it will respond at least with an acknowledgement packet. The addressed slave may respond in the subsequent slot 3 with a 1-slot packet 14 for example. Since in this example the packet sent by the second slave occupies only one slot, the master is free to address slave 1 in slot 4 with a 1-slot packet 16. If the master does not perform any transmission in slot 6, no slave is allowed to send in the subsequent odd numbered slot. Finally, the master may send a one slot packet 20 to slave 2 in slot 8. Slave two then responds with a 3-slot packet 22 in slots 9-11.

FIG. 3 illustrates a protocol stack of a dual mode wireless radio chip in accordance with some embodiments of the present invention. As illustrated in FIG. 3, a dual mode wireless radio chip may comprise a Bluetooth protocol stack and a 802.11 protocol stack. The Bluetooth protocol stack comprises a radio layer (not shown), a baseband layer, a link manager protocol layer (LMP) and a logical link control & adaptation protocol layer (L2CAP). The radio layer, which resides below the baseband layer, defines the technical characteristics of the Bluetooth radios. Bluetooth radios may comprise three power classes, depending on their transmitting power. Class 1 radios have transmitting power of 20 dBm (100 mW); class 2 radios have transmitting power of 4 dBm (2.5 mW); class 3 radios have transmit power of only 0 dBm (1 mW).

The baseband layer defines the key procedures that enable devices to communicate with each other using the Bluetooth wireless technology. The baseband defines the Bluetooth piconets and how they are created and the Bluetooth links. It also defines the low-level packet types. The LMP is a transaction protocol between two link management entities for performing communication between two Bluetooth devices whose responsibilities is to setup the properties of the link. The L2CAP layer shields the specifics of the Bluetooth lower layers and provides a packet interface to higher layers. At L2CAP, the concept of master and slave devices is irrelevant.

The Bluetooth communication system provides several operational modes of which are utilized to alternate between Bluetooth and IEEE 802.11 in a single dual mode wireless radio chip. Being a technology optimized for portable devices with constrained power resources, Bluetooth offers various operational modes (also called power saving modes) which are used to reduce the duty cycle of devices. These operational modes include a hold mode, a park mode and a sniff mode.

In the hold mode, the ACL link to a slave may be put in a hold state. As such, the slave temporarily does not support ACL packets on the channel, but SCO links are still supported. With this mode, capacity may be made free to do other things such as attending another piconet or, in accordance with the present invention, accessing an IEEE 802.11 network. Therefore, rather than communicating with another piconet, the mode may be utilized to communicate with a WLAN. Prior to entering the hold mode, the master and slave agree on the time duration the slave remains in the hold mode. When the timer is expired, the slave will wake up, synchronize to the traffic on the channel, and will wait for further instructions from the master.

Alternatively, when a slave does not need to participate on the piconet channel at all, but still wants to remain synchronized to the channel, it may be set to the park mode. The park mode is used when the device is completely interactive with the IEEE 802.11 system for a given amount of time, and does not want to use the resources in the Bluetooth network.

Finally, Bluetooth provides the sniff mode. The purpose of sniff mode is to reduce the duty cycle on a link between two devices by negotiating specific slots (sniff slots) where communication between devices can begin. If no communication takes place at these slots, the devices may spend the time until the next sniff slots in a low power mode. Otherwise, the communication period (sniff event) may be extended dynamically until one of the devices decides to end the communication. The other device aborts the communication if it does not receive anything on the link for a configurable amount of slots. This behavior is specified for slave devices only. However, if a master does not receive any communication from a slave for some time (e.g., due to transmission errors), the master assumes that the slave has already gone back to low power state.

Referring once again to FIG. 3, the dual mode wireless radio chip is configured to comprise an IEEE 802.11 protocol stack. Like any IEEE 802.x protocol, the IEEE 802.11 protocol covers the MAC (Medium Access Protocol) and the physical layers (PHY). The standard currently defines a single MAC which interacts with three PHYs as follows: Frequency Hopping Spread Spectrum in the 2.4 GHz Band, Direct Sequence Spread Spectrum in the ISM unlicensed 2.4 GHz frequency band, and Infrared. The IEEE 802.11 MAC layer defines two different access methods, the Distributed Coordination Function (PCF), also called Ad Hoc mode, and the Point Coordination Function (PCF), as known as the Infrastructure mode. The PCF mode is today's premier choice of interfacing wireless users with the Internet.

The basic service set (BSS) is the fundamental building block of the IEEE 802.11 system. A BSS is defined as a group of stations that are under the direct control of a single coordination function (i.e., DCF or PCF). An ad hoc network (used in DCF) is a deliberate grouping of stations into a single BSS for the purposes of internet-connected communications without the aid of an infrastructure network. Any station can establish a direct communication session with any other station in the BSS, without the requirement of passing all traffic through a centralized access point (AP).

In contrast to the ad hoc network, an infrastructure network is established to provide wireless users with specific services and range extension. Infrastructure networks in the context of IEEE 802.11 are established using APs. The AP is analogous to the base station is a cellular communications network. An important feature of the PCF which is useful in a dual mode architecture is its polling scheme, which is similar to Bluetooth. In other words, the AP polls the stations in order for them to transmit data. Therefore, a dual mode wireless radio chip may effectively make use of this scheme to schedule Bluetooth and IEEE 802.11 transmissions in accordance with embodiments of the present invention.

FIG. 3 also illustrates a top radio access control protocol layer (RAC), which acts as a bridge between the two protocols, as well as a packet router. This layer receives and forwards transmission packets to and from the Bluetooth and IEEE 802.11 networks utilizing a single antenna. The RAC protocol layer may be implemented within the dual mode wireless radio chip, according to some embodiments of the present invention. The RAC protocol layer, located on top of both the Bluetooth core protocol layer and the IEEE 802.11 MAC layer, is responsible for multiplexing the two communication protocols in radio access. As described above, FIG. 3 illustrates the RAC protocol layer with the IEEE 802.11 on the left and the Bluetooth protocols of the right. The RAC protocol layer multiplexes between both systems and, for efficiency purposes, it may be implemented in hardware in one embodiment of the present invention. However, according to other exemplary embodiments of the present invention, the RAC protocol layer may be implemented in software.

The RAC protocol layer receives packets from upper layers (possibly the network layer) and forwards the packet through the specified system to a corresponding protocol layer. Similarly, it forwards packets received in the wireless interface and either propagates the packet to the upper layer, or it may also directly send the packet through the corresponding stack. In other words, the RAC protocol layer may work both as extension of the routing layer, as well as function as a bridge by interconnecting the two technologies. The RAC protocol layer possesses some of the functionality of a LLC (Link Layer Control) protocol in addition to a multiplexing scheme specifically designed for coexistence of IEEE 802.11 and Bluetooth. Diverse protocols may be developed on top of the RAC protocol layer to implement specific functions including: synchronization of transmissions between IEEE 802.11 and Bluetooth in order to effectively mitigate interference and thus improve performance, application specific protocols to make use of both technologies, and the like.

According to one exemplary embodiment of the present invention, a multiplexing scheme is implemented within the RAC protocol layer. The scheme enables wireless access by the Bluetooth and IEEE 802.11 systems one at a time. For instance, if a given Bluetooth device requests a web page that needs to be retrieved using the IEEE 802.11 infrastructure, packets flowing in both directions should be multiplexed between these two protocol layers of FIG. 3 in a synchronized manner. Devices which possess the one-chip, dual mode IEEE 802.11 and Bluetooth wireless radio interface chip are referred to as Bluetooth Wireless Gateways (BWGs).

The synchronization of the multiplexing is accomplished by utilizing the available Bluetooth operational modes described above. The RAC protocol layer is responsible for negotiating with both the 802.11 MAC and the Bluetooth LMP protocol, illustrated in FIG. 3. The RAC protocol layer maintains the schedule of both the Bluetooth and IEEE 802.11 systems and puts the respective system in the appropriate operational mode to coordinate medium access. This schedule is established according to the requirements of the application and may be changed dynamically as the requirements of the application change.

The RAC protocol layer instructs the Bluetooth and IEEE 802.11 protocol layer to enter a specific operational mode in accordance to a specific communication scenario. These scenarios include an IEEE 802.11-only scenario, a Bluetooth-only scenario, a cooperative data scenario, and a cooperative voice scenario.

The IEEE 802.11-only scenario is a situation in which applications requiring only Internet access provided by the IEEE 802.11 network have their Bluetooth protocol stack put into park mode by the RAC protocol layer. In this scenario, the Bluetooth network would hardly be accessed.

On the other hand, during a Bluetooth-only Scenario, the Bluetooth device is engaged in Bluetooth-only conversations and does not foresee any access to the IEEE 802.11 network. In this case, the IEEE 802.11 interface would be put in a power saving (PS) mode such that no communication coming from the IEEE 802.11 network would take place with this device. Therefore, only Bluetooth communication occurs.

In this cooperative data scenario, the RAC is responsible for bridging packets from both the IEEE 802.11 network and the Bluetooth network. If a BWG is providing IEEE 802.11 access to other Bluetooth devices within its network (piconet/scatternet), the RAC protocol layer puts the Bluetooth protocol layer in sniff mode so that it may bridge packets between the IEEE 802.11 network and the Bluetooth network. Similarly, a Bluetooth hold mode is utilized during a cooperative voice scenario. The Bluetooth hold mode is used as it supports the use of voice applications. Therefore, voice traffic exists between the Bluetooth network and the IEEE 802.11 network.

The RAC protocol layer not only takes care of scenarios where there is a intercommunication between IEEE 802.11 and Bluetooth by supporting the required bridging of packets between the two systems, but also supports scenarios where a single system is being utilized. Therefore, the dual mode wireless radio chip of the present invention possesses different facets according to the environment where the device is located, and the corresponding services available in that area.

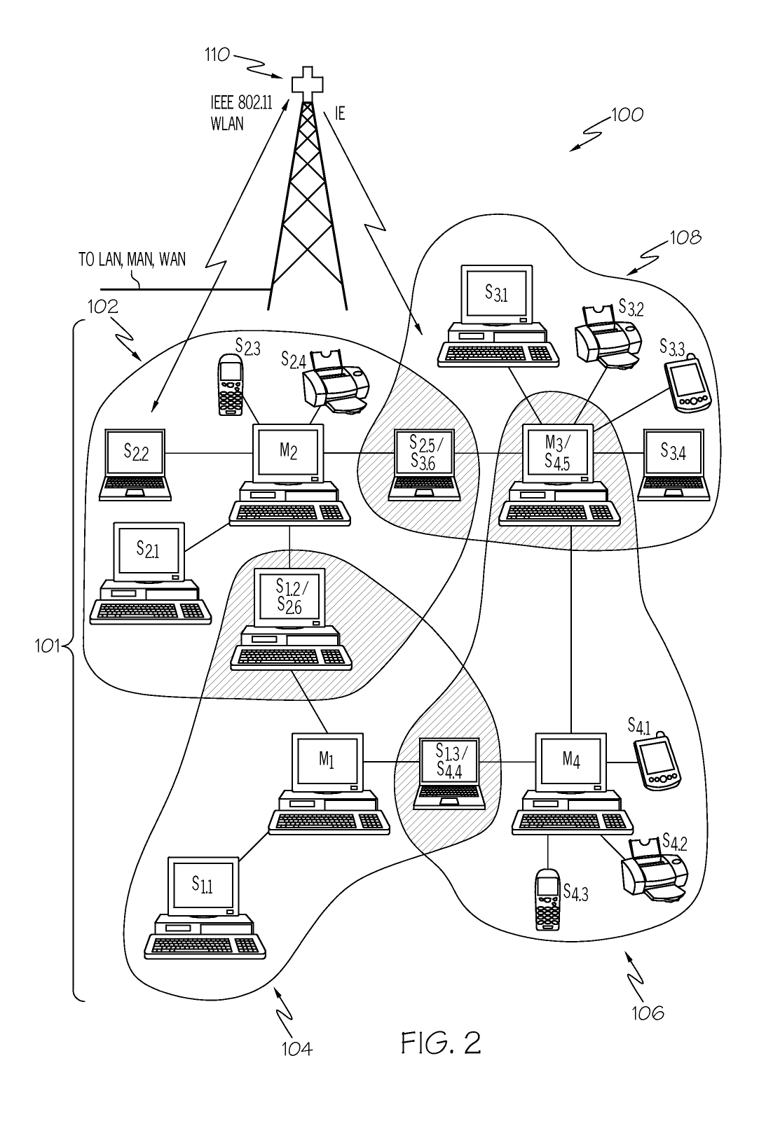

FIG. 2 illustrates a WLAN and WPAN network 100 utilizing embodiments of the present invention. The dual mode architecture of the present invention is capable of accessing networked information, especially through a WAN such as the Internet. This allows dynamic content to be delivered to the piconets and which in turn, either directly or through the scatternet, enabled access to the devices that may not otherwise have such WAN access. This also enables network sharing among wireless and wired devices not only within the local network, but also across the WAN. This novel architecture provides Bluetooth access to the WAN and take advantage of the existing IEEE 802.11 WLANs 110. Devices within a network may include, but is not limited to, a desktop, notebook, cell phone, PDA or printer. Piconets may be formed around a portable device that is a BWG and is configured with the dual mode wireless radio chip, and have wide-area connectivity as well. FIG. 2 illustrates the network 100 as a scatternet 101, composed of total of four piconets 102, 104, 106 and 108, where each piconet has several slaves (indicated by the letter S_{i,j}) and one master (indicated by the letter Mᵢ). A master may be a master in one piconet and a slave in another, as indicated in piconet 108. In FIG. 2, four BWGs provide the scatternet 101 Bluetooth devices access to the local WLAN 110 which, in turn, provides communication to the local LAN, MAN, or WAN 110, and possibly the Internet. This enables Bluetooth devices across the Bluetooth piconet/scatternet to make use of the services provided by a BWG and, therefore, communicate with virtually any other entity on the Internet.

To further increase the performance benefits gained with the dual mode wireless radio chip based on BWGs, an interference mitigation module may be implemented on top of the RAC protocol layer. This module is employed to schedule Bluetooth and IEEE 802.11 transmissions in such a way to eliminate potential interference conditions. Using this integration module, Bluetooth with a dual mode wireless radio chip comprising a RAC protocol layer practically doubles the maximum bandwidth achieved by the normal Bluetooth implementation in any of the above described scenarios. While the maximum throughput achieved by a standard Bluetooth network is of the order of 8 Mbps when there are 60 piconets in the network, Bluetooth with a dual mode wireless radio chip comprising a RAC protocol layer may be increased 15.5 Mbps for a total of 90 piconets, for example. Thus, not only man the RAC protocol layer drastically increase throughput but it also enables efficient support of a larger number of co-located piconets. Through a configuration module, the RAC protocol layer identifies communication between the Bluetooth network and the IEEE 802.11 network, and schedules packet transmissions according to the operational modes previously described. This enables the effective multiplexing between the two systems, and the consequent dramatic performance gain observed in this integrated environment.

The foregoing description of the various embodiments and principles of the inventions has been presented for the purpose of illustration and description. It is not intended to be exhaustive or to limit the invention to the precise forms disclosed. Many alternatives, modifications and variations will be apparent to those skilled in the art. Moreover, although many inventive aspects have been presented, such aspects need not be utilized in combination, and various combinations of inventive aspects are possible in light of the various embodiments provided above. Accordingly, the above description is intended to embrace all possible alternatives, modifications, combinations and variations that have been discussed or suggested herein, as well as others that fall within the principles, spirit, and broad scope of the various inventions as defined by the claims.

What is claimed is:

1. A dual mode wireless radio chip having integrated circuitry enabled to provide:
a wireless personal area network protocol layer;
a wireless local area network protocol layer; and
a radio access control protocol layer comprising a single antenna configured to receive and forward a plurality of transmission packets, and to multiplex the wireless personal area network protocol layer and the wireless local area network protocol layer by placing the wireless personal area network protocol layer and the wireless local area network protocol layer in one or more plurality of operational modes, wherein the radio access control protocol layer provides wireless local area network communication and wireless personal area network communication simultaneously to a plurality of wireless personal area network enabled devices.

2. The chip of claim 1 wherein the wireless personal area network protocol layer is compatible with Bluetooth™; and the wireless local area network protocol layer is compatible with IEEE 802.11.

3. The chip of claim 1 wherein the plurality of operational modes comprise a park mode, a power saving mode, a sniff mode, and a hold mode.

4. The chip of claim 3 wherein the radio access control protocol layer is configured to place the wireless personal area network in a park mode during a wireless local area network-only scenario.

5. The chip of claim 3 wherein the radio access control protocol layer is configured to place the wireless local area network protocol layer in a power saving mode during a wireless personal area network-only scenario.

6. The chip of claim 3 wherein the radio access control protocol layer is configured to place the wireless personal area network protocol layer in a sniff mode during a cooperative data scenario.

7. The chip of claim 1 wherein the radio access control protocol layer is configured to place the wireless personal area network protocol layer in a hold mode during a cooperative voice scenario.

8. The chip of claim 1 wherein:
the radio access control protocol layer functions as a router layer to the wireless local area network protocol layer during a wireless personal area network-only scenario; and
the radio access control protocol layer functions as a router layer to the wireless personal area network protocol layer during a wireless personal area network-only scenario.

9. The chip of claim 1 wherein the dual mode wireless radio chip further comprises an interference mitigation module implemented on top of the radio access control protocol layer, wherein the interference mitigation module is configured to schedule a plurality of wireless personal area network transmissions and a plurality of wireless local area network transmissions in such a way to eliminate interference conditions.

10. The chip of claim 1 wherein the dual mode wireless radio chip is configured to provide the plurality of wireless personal network devices access to a local area network, a wide area network or a municipal area network.

11. The chip of claim 1 wherein the radio access control protocol layer is configured to receive packets from a wireless local area network access point, the wireless personal area network protocol layer and the wireless local area network protocol layer.

12. The chip of claim 1 wherein the radio access control protocol layer is configured to forward packets to a wireless local area network access point, the wireless personal area network protocol layer and the wireless local area network protocol layer.

13. The chip of claim 1 wherein:
the radio access control protocol layer functions as a router layer to the wireless local area network protocol layer during a wireless personal area network-only scenario by sending packets to a corresponding stack; and
the radio access control protocol layer functions as a router layer to the wireless personal area network protocol layer during a wireless personal area network-only scenario by sending packets to a corresponding stack.

14. A method of multiplexing a wireless local area network communication protocol and a wireless personal area network communication protocol, the method comprising:
providing a dual mode wireless radio chip in a device, the dual mode wireless radio chip comprising a wireless personal area network protocol layer and a wireless local area network protocol layer;
receiving a transmission packet from a wireless local area network access point;
determining whether a wireless local area network-only scenario, a wireless personal area network-only scenario, a cooperative data scenario or a cooperative voice scenario is present;
placing the wireless personal area network protocol layer in a park mode if a wireless local area network-only scenario is present, wherein the wireless personal area network is not accessed;
placing the wireless network area network protocol layer in a power save mode if a wireless personal area network-only scenario is present, wherein the device does not receive packets from the wireless local area network;
placing the wireless personal area network protocol layer in a sniff mode if a cooperative data scenario is present, wherein when a wireless local area network packet is being received, the wireless personal area network protocol layer is suspended until a wireless local area network packet is completed;
placing the wireless personal area network protocol layer in a hold mode if a cooperative voice scenario is present, wherein during a predetermined hold time duration the wireless personal area network protocol layer is suspended and wireless local area network packets are sent and received; and
forwarding the transmission packet to the wireless personal area network protocol layer or the wireless local area network protocol layer.

15. The chip of claim 14 wherein a radio access control protocol layer places the wireless personal area network in the park mode, sniff mode or hold mode, and places the wireless local network in the power saving mode.

16. The chip of claim 15 wherein the radio access control protocol layer is configured as circuitry within the dual mode wireless radio chip.

17. The chip of claim 15 wherein the radio access control protocol layer is implemented as software within the wireless local area network and the wireless personal area network.

18. A wireless personal area network and wireless local area network system comprising:
a wireless local area network access point, wherein the wireless local area network access point transmits and receives a plurality of wireless local area network transmission packets;
a wireless personal device network comprising:
a plurality of slave devices configured to have wireless personal area network access; and
at least one wireless gateway device, the at least one wireless gateway device comprising a dual mode wireless radio chip having integrated circuitry enabled to provide:
a wireless personal area network protocol layer;
a wireless local area network protocol layer; and
a radio access control protocol layer comprising a single antenna, wherein the radio access control protocol layer is configured place the wireless personal area network protocol layer and the wireless local area network protocol layer in one or more plurality of operational modes, thereby providing wireless local area network communication and wireless personal area network communication simultaneously to a plurality of wireless personal area network enabled devices; and
whereby the at least one wireless gateway device provides the wireless personal device network access to a wireless local area network.

19. The chip of claim 18 wherein the device network further comprises a scatternet defined by at least one piconet, the piconet comprising the plurality of devices.

20. The chip of claim 19 wherein an aggregate maximum bandwidth of a scatternet defined by 90 piconets is approximately 15.5 Mbps.
